(19) United States
(12) Patent Application Publication
(10) Pub. No.: US 2026/0034759 A1
(43) Pub. Date: Feb. 5, 2026

(54) Apparatus and method for dry forming cellulose products

(71) Applicant: Fameccanica.Data S.p.A., San Giovanni Teatino Chieti (IT)

(72) Inventors: Alessandro CIPRIANI, San Giovanni Teatino Chieti (IT); Diego GUALTIERI, San Giovanni Teatino Chieti (IT)

(21) Appl. No.: 19/286,734

(22) Filed: Jul. 31, 2025

(30) Foreign Application Priority Data
Aug. 1, 2024 (IT) 102024000018082

(51) Int. Cl. B31D 1/04; D21D 1/04; D21J 3/12

(52) U.S. Cl. CPC B31D 1/04; D21D 1/04; D21J 3/12

(57) ABSTRACT

Apparatus for dry forming cellulose products includes a forming wheel having an external surface provided with a plurality of discrete forming seats having a variable depth.

### FIELD OF THE INVENTION

The present invention relates in general to the production of cellulose products.

More specifically, the invention concerns an apparatus and a method for dry forming cellulose products.

The invention was developed in particular for producing soluble beverage capsules or container caps.

However, the invention is not limited to this specific field and can be used for producing a wide range of two-dimensional or three-dimensional such products, as containers, boxes, disposable plates, cups, packaging products for solid or liquid goods, and other types of disposable items.

### BACKGROUND OF THE INVENTION

Many disposable items, such as soluble beverage capsules, container caps, packaging products, etc., are still made from plastic materials that have significant energy and environmental impacts both in their production and recycling. There is a strong need for sustainable, recyclable products in the paper chain.

Products made from cellulose fibers can be used in many cases where disposable items with greater sustainability than plastic products are required.

Recently, new processes have been developed for dry forming three-dimensional products consisting of cellulose fibers.

Current prior art solutions for producing cellulose products using dry-molding technology involve a mill that defibrates the cellulose. The defibrated cellulose is typically conveyed onto a forming belt where a mat of cellulose fibers with uniform thickness and variable width, generally around 600 mm, is formed. The forming belt and the cellulose fiber mat advance at constant speed. The cellulose fiber mat, which may have basis weights in the range of 300-900 gsm, is coupled with two tissue paper layers placed on opposite sides of the cellulose fiber mat. Then, a spray additive phase is performed with liquid additives, such as AKD, latex, etc., in a 5-20% aqueous solution. Subsequent steps include calendering to achieve as uniform a thickness as possible, die-cutting, and pressing, which are performed in intermittent and indexed modes. Between the continuous forming phase and the indexed pressing, a buffer consisting of a variable-sized loop is formed. The final products are generated through three-dimensional pressing of a flat starting material with uniform thickness.

Examples of cellulose product forming methods using dry-molding techniques are described, for instance, in WO2021001276A1 and WO2019209160A1. These documents describe methods for producing cellulose products, comprising the steps of forming a multilayer raw cellulose structure consisting of at least a first and a second layer of dry-formed cellulose fibers, placing the multilayer raw cellulose structure in a forming mold, heating the multilayer raw cellulose structure to a forming temperature between 100° C. and 300° C., and forming the cellulose product from the multilayer raw cellulose structure in a forming mold by pressing the heated multilayer cellulose with an isostatic forming pressure of at least 1 MPa, preferably 4-20 MPa, so that the multilayer raw cellulose structure is shaped into a two-dimensional or three-dimensional fiber composite structure having a single-layer configuration.

The prior art solutions, as described above, involve creating a uniform cellulose mat that is poorly suited for producing products with variable basis weight and strength. The strength of the final product depends on the amount of fibers pressed per unit area. The higher the basis weight of a zone, the greater its density and strength.

This need arises when products with zones of variable functionality are desired, such as coffee capsules where the center of the capsule must have lower strength to be pierced, while the side zones must have higher strength as they serve a structural support function during use. The same applies to threaded caps, where the base and side portions serve different functions: the base must ensure product sealing in the bottle, while the side portion must have an applied thread and mechanical functionality.

Another issue with prior art solutions is the cellulose waste generated in the space between adjacent products obtained from a continuous mat of cellulose fibers.

### OBJECT AND SUMMARY OF THE INVENTION

The object of the present invention is to provide an apparatus and a method for dry forming cellulose products that overcome the problems of the prior art.

According to the present invention, this object is achieved by an apparatus according to claim 1 and a method according to claim 9.

Preferred embodiments of the invention form the subject of the dependent claims.

The claims are an integral part of the teaching provided in relation to the invention.

### BRIEF DESCRIPTION OF THE DRAWINGS

The present invention will now be described in detail with reference to the accompanying drawings, provided only by way of non-limiting example, in which:

FIG. 1 is a schematic side view of an apparatus for dry forming cellulose products,

FIG. 2 is a perspective view of a sector of the external surface of a forming wheel indicated by arrow II in FIG. 1, and

FIG. 3 is a cross-section along line III-III of FIG. 2.

It will be appreciated that the accompanying drawings are schematic and some components may not be shown to simplify understanding of the figures.

### DETAILED DESCRIPTION

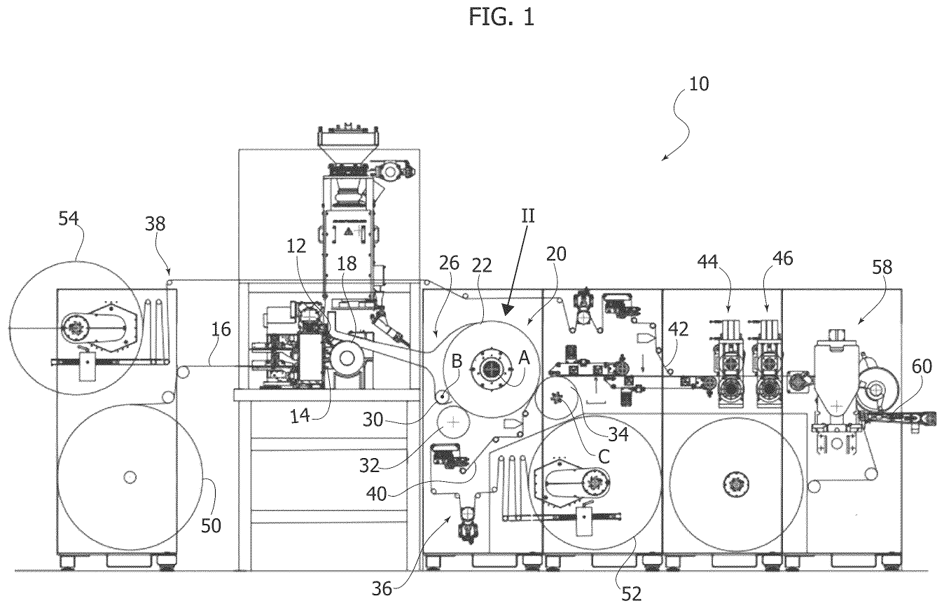

With reference to FIG. 1, numeral 10 denotes an apparatus for dry forming cellulose products.

The apparatus 10 comprises a defibrating mill 12 for defibrating cellulose sheets. Defibrating mills are generally used to convert sheets of fibrous material, such as paper or cardboard sheets, into a dispersion of loose fibers. Defibrating mills are typically employed for producing cellulose fluff, used as absorbent mass in production lines for absorbent sanitary articles.

The defibrating mill 12 may be a disc mill, including a support housing with a seat inside which a rotor comprising a stack of toothed discs is rotatably mounted.

The defibrating mill 12 has an inlet section 14 configured to receive a cellulose sheet 16 unwound from a reel 50 and an outlet section 18 configured to provide a flow of loose cellulose fibers.

The apparatus 10 comprises a forming wheel 20 rotatable about a rotation axis A. With reference to FIGS. 1-3, the forming wheel 20 has an external surface 22 provided with a plurality of discrete forming seats 24 configured for forming blanks of cellulose products.

With reference to FIG. 1, the apparatus 10 comprises a fiber deposition chamber 26 configured to receive a flow of loose cellulose fibers from the outlet section 18 of the defibrating mill 12. The fiber deposition chamber 26 faces a sector of the external surface 22 of the forming wheel 20 for depositing loose cellulose fibers into the discrete forming seats 24. An air flow may be supplied inside the fiber deposition chamber 26 to convey the loose cellulose fibers toward the discrete forming seats 24 of the forming wheel 20.

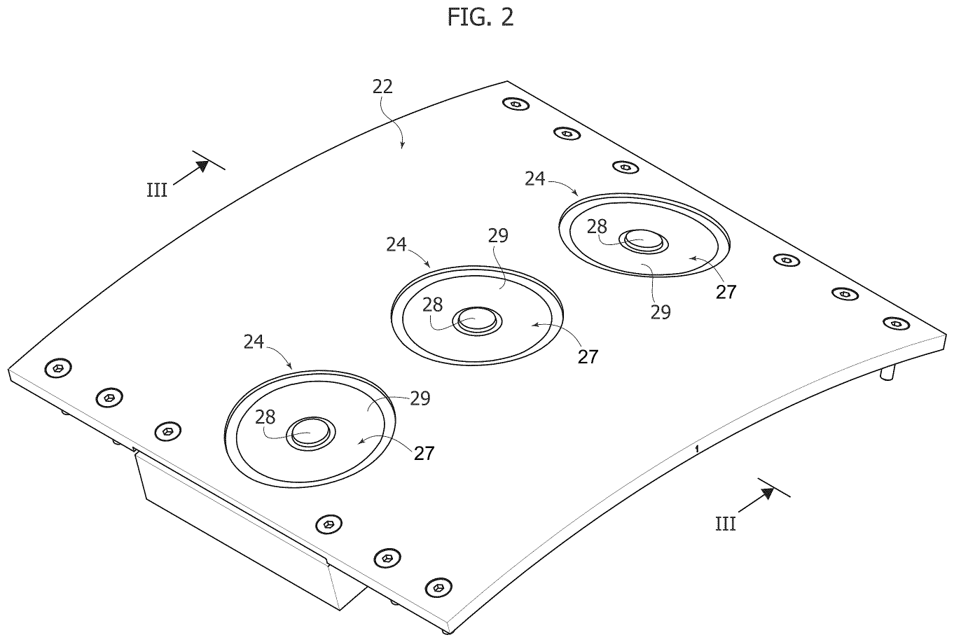

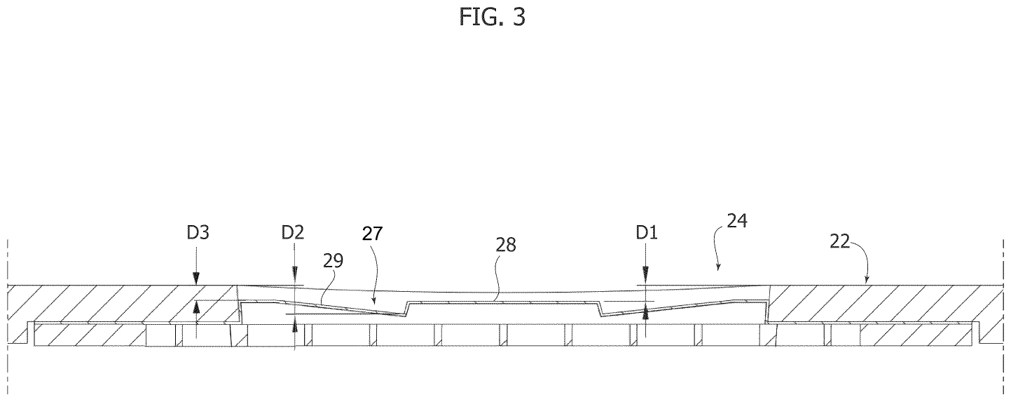

With reference to FIGS. 2 and 3, each of the discrete forming seats 24 has a bottom wall 27 recessed relative to the external surface 22. The bottom wall 27 of each of the discrete forming seats 24 may be provided with suction holes connected to a suction source to retain the loose cellulose fibers within the discrete forming seats 24 by suction.

The bottom wall 27 of each of the discrete forming seats 24 has variable depth. In particular, a central portion 28 of each of the discrete forming seats 24 has a depth D1 less than a depth D2, D3 of an annular portion 29 surrounding the central portion 28.

The annular portion 29 may have a tapered profile from the inside outward, with a greater depth D2 near the central portion 28 and a lesser depth D3 near an outer edge of the respective discrete forming seat 24. Any section of the annular portion 29 has a depth between D2 and D3 less than the depth of the central portion 28.

Each of the discrete forming seats 24 may have an outer edge with a circular shape. The central portion 28 of each of the discrete forming seats 24 may also have a circular shape coaxial with the edge of the respective discrete forming seat 24.

The solution according to the present invention allows forming discrete blanks of cellulose products with variable basis weight on a wheel.

The discrete forming seats 24 replicate the negatives of the product blanks. The portions of the discrete forming seats 24 where the depth is greater generate portions of the product blanks with higher basis weight, and those where the depth of the discrete forming seats 24 is lesser generate portions of the product blanks with lower basis weight.

The central portion 28 may have a diameter varying from 15 mm to 30 mm. The outer diameter of each of the discrete forming seats 24 may vary from 70 mm to 90 mm.

The basis weight of the different portions of the cellulose product blanks may vary between 200-1000 gsm.

With reference to FIG. 3, the central portion 28 of each of the discrete forming seats 24 has a depth D1 that may be between 1 and 3 mm, preferably between 1.5 and 2.5 mm. With this depth of the central portion 28, cellulose product blanks can be produced having a central portion with a basis weight on the order of 180±30 gsm.

The annular portion 29 of each of the discrete forming seats 24 may have a depth D2 near the central portion 28 that may be between 2 and 5 mm, preferably between 2.5 and 4.5 mm, which allows obtaining a basis weight on the order of 280±30 gsm, and a depth D3 near the outer edge that may be between 1.2 and 2.5 mm, preferably 1.5 and 2 mm, which allows obtaining a basis weight on the order of 150±30 gsm.

The relationship between the depth of the discrete forming seats 24 and the basis weight of the different portions of the cellulose product blanks depends on various factors, such as the diameter of the forming wheel 20, the air speed in the fiber deposition chamber 26, and the suction generated inside the discrete forming seats 24.

Blanks with variable basis weight are particularly useful when producing cellulose products with zones having different functions, as soluble beverage capsules (typically coffee) where the center of the capsule must have lower strength to be easily pierced, while the side zones must have higher strength as they serve a structural support function during use. A similar need arises in the case of caps, where the base must ensure product sealing in the bottle while the side portion must have an applied thread and mechanical functionality.

With reference to FIG. 1, a particularly important feature for producing cellulose product blanks with the aforementioned characteristics is that the apparatus 10 comprises a leveling roller 30 rotatable about a rotation axis B parallel to the rotation axis A of the forming wheel 20. The leveling roller 30 cooperates with the external surface 22 of the forming wheel 20 and is located in a terminal section of the fiber deposition chamber 26.

The leveling roller 30 during operation rotates about its rotation axis B at a very high speed, for example between 1000-3000 rpm.

A particularly significant feature is that the forming of the cellulose product blanks occurs on a wheel. This is important because it ensures that the leveling roller 30 cooperates with a rigid surface and can maintain a constant gap thickness with the external surface 22 of the forming wheel 20 to ensure effective leveling action.

The gap defined between the leveling roller 30 and the external surface 22 of the forming wheel 20 may have a thickness between 0.7-1.5 mm.

This gap must be precise and constant since the thickness of said gap influences the basis weight of the cellulose product blanks. To precision ensure and consistency of the gap, the external surface 22 must have very tight tolerances, on the order of +/−0.1 mm, which is relatively easy to achieve on a mechanically axially symmetrical component like the external surface 22 of the forming wheel 20, whereas it would be very difficult to maintain such tolerances on a flexible element like a belt.

The leveling roller 30 may comprise a plurality of shaped discs. The shaping of the discs of the leveling roller 30, combined with the high rotational speed and vacuum retention, allows for fine removal of excess cellulose fibers without creating holes and/or inhomogeneities in the cellulose product blanks.

The effect of suction inside the discrete forming seats 24 combined with the presence of a leveling roller 30 that removes excess cellulose fibers enables proper filling of the discrete forming seats 24 and the formation of cellulose product blanks with the correct basis weight distribution. This way, three-dimensional products such as coffee capsules with zones of higher stiffness and zones of lower stiffness can be produced.

In a preferred embodiment, the apparatus 10 comprises a pressing wheel 32 located downstream of the fiber deposition chamber 26 and rotationally driven in phase with the forming wheel 20, configured to press the loose cellulose fibers in the discrete forming seats 24.

This feature allows for pre-compaction of the fibers before transferring the cellulose product blanks to other phases of the production process. This ensures greater stability of the cellulose products formed from the blanks exiting the apparatus 10, preventing deformations during transfer phases.

The apparatus 10 comprises a detachment wheel 34 tangent to the external surface 22 of the forming wheel 20 and rotatable about a rotation axis C parallel to the rotation axis A of the forming wheel 20. The detachment wheel 34 is configured to detach cellulose product blanks from respective discrete forming seats 24. For example, the detachment wheel 34 may pick up the cellulose product blanks by suction from respective discrete forming seats 24.

The apparatus 10 may comprise a first and a second feeding device 36, 38 configured to feed a first and a second tissue paper layer 40, 42 on opposite sides of an array of cellulose product blanks. The first and second tissue paper layers 40, 42 are unwound from respective reels 52, 54. The first tissue paper layer 40 is fed between the forming wheel 20 and the detachment wheel 34, and the second tissue paper layer 42 is fed onto the array of cellulose product blanks downstream of the detachment wheel 34.

In possible embodiments, the apparatus 10 may comprise a pressing unit 44 and/or an embossing unit 46 configured to perform pressing and/or in-phase embossing of the blanks downstream of the detachment wheel 34.

The pressing and/or in-phase embossing of discrete cellulose product blanks with variable basis weight can facilitate the initiation of folding lines in the blanks when they are inserted into molds for forming the final products, ensuring repeatability and precision in the molding phase.

The apparatus 10 may comprise a cutting unit 58 for cutting the chain of cellulose product blanks positioned downstream of the pressing unit 44 and the embossing unit 46.

Downstream of the cutting unit, the cellulose product blanks are sent to an output station 60 and from there to subsequent process phases (e.g., hot pressing, etc.) for transforming the blanks into finished products.

In operation, the previously described apparatus 10 implements a method for dry forming cellulose product blanks comprising:
feeding a cellulose sheet 16 to an inlet section 14 of a defibrating mill 12 and providing a flow of loose cellulose fibers at an outlet section 18 of the defibrating mill 12,
providing a forming wheel 20 rotatable about a rotation axis A and having an external surface 22 provided with a plurality of discrete forming seats 24 configured for forming cellulose product blanks,
sending the flow of loose cellulose fibers from the outlet section 18 of the defibrating mill 12 to a fiber deposition chamber 26 facing a sector of the external surface 22 of the forming wheel 20 and depositing loose cellulose fibers into the discrete forming seats 24,
wherein each of the discrete forming seats 24 has a bottom wall 27 recessed relative to the external surface 22 of the forming wheel 20, wherein the bottom wall 27 has variable depth, and wherein a central portion 28 of each of the discrete forming seats 24 has a depth D1 less than a depth D2, D3 of an annular portion 29 surrounding the central portion 28.

The method may comprise leveling the loose cellulose fibers in the discrete forming seats 24 by a leveling roller 30 rotatable about a rotation axis B parallel to the rotation axis A of the forming wheel 20, cooperating with the external surface 22 of the forming wheel 20, and located in a terminal section of the fiber deposition chamber 26.

Naturally, while maintaining the principle of the invention, construction details and embodiments may be widely varied from what has been described and illustrated without departing from the scope of the invention as defined by the following claims.

1. An apparatus for dry forming cellulose products, comprising:
a defibrating mill having an inlet section configured to receive a cellulose sheet and an outlet section configured to provide a flow of loose cellulose fibers,
a forming wheel rotatable about a rotation axis and having an external surface provided with a plurality of discrete forming seats configured for forming cellulose product blanks, and
a fiber deposition chamber configured to receive said flow of loose cellulose fibers from said outlet section of the defibrating mill and facing a sector of said external surface of the forming wheel for depositing loose cellulose fibers into said plurality of discrete forming seats,
wherein each discrete forming seat of said plurality of discrete forming seats has a bottom wall recessed relative to said external surface, said bottom wall having variable depth, and
wherein a central portion of each discrete forming seat has a depth less than a depth of an annular portion surrounding said central portion.

2. The apparatus of claim 1, comprising a leveling roller rotatable about a second rotation axis parallel to the rotation axis of the forming wheel, cooperating with the external surface of the forming wheel and located in a terminal section of said fiber deposition chamber.

3. The apparatus of claim 2, wherein in operation said leveling roller rotates about its second rotation axis at a speed between 1000 and 3000 rpm.

4. The apparatus of claim 2, wherein between said leveling roller and said external surface of the forming wheel is defined a gap having a thickness between 0.7 and 1.5 mm.

5. The apparatus of claim 1, comprising a pressing wheel located downstream of said fiber deposition chamber and configured to perform in-phase pressing of the loose cellulose fibers in said discrete forming seats.

6. The apparatus of claim 1, comprising a detachment wheel tangent to the external surface of the forming wheel and rotatable about a third rotation axis parallel to the rotation axis of the forming wheel, configured to detach cellulose product blanks from respective discrete forming seats.

7. The apparatus of claim 1, comprising a first and a second feeding device configured to feed a first and a second tissue paper layer on opposite sides of an array of cellulose product blanks.

8. The apparatus of claim 6, comprising a pressing unit and/or an embossing unit configured to perform pressing and/or embossing of said cellulose product blanks downstream of said detachment wheel.

9. A method for dry forming cellulose products, comprising:
feeding a cellulose sheet to an inlet section of a defibrating mill and providing a flow of loose cellulose fibers at an outlet section of the defibrating mill,
providing a forming wheel rotatable about a rotation axis and having an external surface provided with a plurality of discrete forming seats configured for forming cellulose product blanks, and
sending said flow of loose cellulose fibers from said outlet section of said defibrating mill to a fiber deposition chamber facing a sector of said external surface of the forming wheel and depositing loose cellulose fibers into said plurality of discrete forming seats,
wherein each discrete forming seat of said plurality of discrete forming seats has a bottom wall recessed relative to said external surface of the forming wheel, said bottom wall having variable depth, and
wherein a central portion of each discrete forming seat has a depth less than a depth of an annular portion surrounding said central portion.

10. The method of claim 9, comprising leveling said loose cellulose fibers in said discrete forming seats by a leveling roller rotatable about a second rotation axis parallel to the rotation axis of the forming wheel, cooperating with the external surface of the forming wheel and located in a terminal section of said fiber deposition chamber.
